(19) United States
(12) Patent Application Publication
(10) Pub. No.: US 2025/0014254 A1
(43) Pub. Date: Jan. 9, 2025

(54) METHOD FOR DISPLAYING LIVE-STREAMING VIRTUAL RESOURCE AND TERMINAL

(71) Applicant: BEIJING DAJIA INTERNET INFORMATION TECHNOLOGY CO., LTD., Beijing (CN)

(72) Inventors: Kuixin DENG, Beijing (CN); Minxuan LIN, Beijing (CN); Haibin HUANG, Beijing (CN)

(21) Appl. No.: 18/583,041

(22) Filed: Feb. 21, 2024

(30) Foreign Application Priority Data
Jul. 6, 2023 (CN) 202310827365.0

(51) Int. Cl. G06T 13/40; G06T 5/50; G06T 7/12; G06T 15/00; H04N 21/2187

(52) U.S. Cl. CPC G06T 13/40; G06T 5/50; G06T 7/12; G06T 15/00; H04N 21/2187; G06T 2207/20221

(57) ABSTRACT

Provided is a method for displaying a live-streaming virtual resource. A virtual avatar animation is acquired, wherein the virtual avatar animation is acquired by processing object image information of a live-streaming room object through an artificial intelligence generative model, and the live-streaming room object is an object associated with a live-streaming room; the virtual avatar animation is configured as a virtual resource associated with the live-streaming room; and the virtual avatar animation is displayed in the live-streaming room in response to satisfying a transfer-triggering condition of the virtual resource.

This disclosure is based on and claims priority to Chinese Patent Application No. 202310827365.0, filed on Jul. 6, 2023, the disclosures of which are herein incorporated by reference in their entireties.

### TECHNICAL FIELD

The present disclosure relates to the technical field of live streaming, in particular, relates to a method for displaying a live-streaming virtual resource and a terminal.

### BACKGROUND

With the development of a live streaming technology, a live-streaming virtual resource can be transferred in a live-streaming room. For example, such a live-streaming virtual resource is a virtual gift in the live-streaming room.

### SUMMARY

The present disclosure provides a method for displaying a live-streaming virtual resource and a terminal. The technical solutions of the present disclosure are as follows:

According to some embodiments of the present disclosure, a method for displaying a live-streaming virtual resource is provided. The method includes the following steps. A virtual avatar animation is acquired, wherein the virtual avatar animation is acquired by processing object image information of a live-streaming room object through an artificial intelligence generative model, and the live-streaming room object is an object associated with a live-streaming room; the virtual avatar animation is configured as a virtual resource associated with the live-streaming room; and the virtual avatar animation is displayed in the live-streaming room in response to satisfying a transfer-triggering condition of the virtual resource.

According to some embodiments of the present disclosure, a method for displaying a live-streaming virtual resource is provided. The method includes the following steps. Object image information of a live-streaming room object associated with a live-streaming room is acquired; a virtual avatar image matched with the object image information is acquired based on the object image information through an artificial intelligence generative model, and a virtual avatar animation adapting to the virtual avatar image is generated, wherein the virtual avatar animation is provided as a virtual resource associated with the live-streaming room; and the virtual avatar animation is displayed in the live-streaming room in response to satisfying a transfer-triggering condition of the virtual resource.

According to some embodiments of the present disclosure, a terminal is provided, the terminal includes a processor and a memory configured to store instructions executable by the processor, wherein the processor, when loading and running the instructions, is caused to perform: acquire a virtual avatar animation, wherein the virtual avatar animation is acquired by processing object image information of a live-streaming room object through an artificial intelligence generative model, and the live-streaming room object is an object associated with a live-streaming room; configure the virtual avatar animation as a virtual resource associated with the live-streaming room; and display the virtual avatar animation in the live-streaming room in response to satisfying a transfer-triggering condition of the virtual resource.

### BRIEF DESCRIPTION OF THE DRAWINGS

FIG. 1 is a diagram of an application environment of a method for displaying a live-streaming virtual resource according to some embodiments;

FIG. 2 is a flowchart of a method for displaying a live-streaming virtual resource according to some embodiments;

FIG. 3 is a flowchart of acquiring account image information according to some embodiments;

FIG. 4 is a schematic diagram of a virtual avatar creation page according to some embodiments;

FIG. 5 is a schematic diagram of another virtual avatar creation page according to some embodiments;

FIG. 6 is a flowchart of displaying a virtual avatar animation of a default virtual avatar according to some embodiments;

FIG. 7 is a flowchart of a method for displaying a live-streaming virtual resource according to some other embodiments;

FIG. 8 is a flowchart of generating a virtual avatar image according to some embodiments;

FIG. 9 is a flowchart of generating a virtual avatar animation according to some embodiments;

FIG. 10 is a flowchart of another method for displaying a live-streaming virtual resource according to some embodiments;

FIG. 11 is a block diagram of an apparatus for displaying a live-streaming virtual resource according to some embodiments;

FIG. 12 is a block diagram of another apparatus for displaying a live-streaming virtual resource according to some embodiments;

FIG. 13 is a block diagram of a terminal according to some embodiments; and

FIG. 14 is a block diagram of a server according to some embodiments.

### DETAILED DESCRIPTION

The terms “first”, “second”, etc. in the specification and claims of the present disclosure and the above accompanying drawings are defined to distinguish similar objects, and do not have to be defined to describe a specific order or sequence. It should be understood that the data so used is interchangeable under appropriate circumstances such that the embodiments of the present disclosure described herein are capable of implementation in other sequences than those illustrated or described herein.

The user information (including, but not limited to, user device information, user personal information, etc.) and data (including, but not limited to, data for display, analyzed data, etc.) referred to in the present disclosure are information and data authorized by users or sufficiently authorized by each party.

With the development of a live streaming technology, a live-streaming virtual resource can be transferred in a live-streaming room. For example, such a live-streaming virtual resource is a virtual gift in the live-streaming room.

However, in the related art, the live-streaming virtual resource is usually preset by a live-streaming platform, and the live-streaming virtual resource typically is fixed and is presented in a single presentation style, and customized presentation for a live-streaming room is not available.

Referring to FIG. 1, a schematic diagram of an application environment of a method for displaying a live-streaming virtual resource according to some embodiments illustrated. In some embodiments, the method for displaying the live-streaming virtual resource is applicable to an application environment as shown in FIG. 1. The terminal 101 interacts with a virtual avatar generation server 102 over a network. In some embodiments, the virtual avatar generation server 102 may be a live-streaming server that provides the live-streaming service. In some embodiment, the virtual avatar generation server 102 may be a server independent from a live-streaming server but is connected to the live-streaming server upon starting of the live-streaming. The terminal 101 acquires a virtual avatar animation from the virtual avatar generation server 102 and configures the virtual avatar animation as a virtual resource of a live-streaming room, wherein the virtual avatar animation is acquired by processing, through an artificial intelligence generative model, object image information of a live-streaming room object associated with the live-streaming room. Afterwards, in the case that a transfer operation on the virtual resource has been detected, the terminal 101 displays the virtual resource in the live-streaming room in response to the transfer operation, that is, displays the virtual avatar animation in the live-streaming room. The terminal 101 includes, but is not limited to, various personal computers, notebook computers, smart phones, tablet computers, Internet of things devices, and portable wearable devices, and the virtual avatar generation server 102 is implemented by an independent server or a server cluster composed of a plurality of servers.

FIG. 2 is a flowchart of a method for displaying a live-streaming virtual resource according to some embodiments. As shown in FIG. 2, the method for displaying the live-streaming virtual resource is executed by a terminal. For example, the terminal is the terminal 101 in FIG. 1. The terminal is a terminal in which an audience account or anchor account is logged.

In 201, the terminal acquires a virtual avatar animation as a virtual resource associated with a live-streaming room, wherein the virtual avatar animation is acquired by processing account image information of a live-streaming room account through an artificial intelligence generative model, and the live-streaming room account is an account associated with the live-streaming room.

The live-streaming room account associated with the live-streaming room refers to an account in the live-streaming room, including an anchor account in the live-streaming room or an audience account in the live-streaming room. In other words, the live-streaming room account refers to a live-streaming room object account associated with the live-streaming room account, and the live-streaming room object refers to an object associated with the live-streaming room. For example, the live-streaming room object includes, but is not limited to: an anchor object, another anchor object that is in joint live streaming with the anchor object, an audience object, and the like. The anchor object is a real person anchor or a virtual anchor controlled by a real person. The embodiments of the present disclosure do not specifically limit the type of the anchor room object.

In 201, the terminal acquires a virtual avatar animation, wherein the virtual avatar animation is acquired by processing object image information of a live-streaming room object through an artificial intelligence generative model, and the live-streaming room object is an object associated with a live-streaming room; and then configures the virtual avatar animation as a virtual resource associated with the live-streaming room. The artificial intelligence generative model is an artificial intelligence technique that can create new content, which can include text, images, video, code, music, etc., based on knowledge and rules learned from data. Neural networks, machine learning, deep learning, and the like are typically used to extract features and patterns from a large amount of data, and then generate outputs similar to or related to the training data based on given inputs or cues. There are various types of artificial intelligence generative models, such as generative confrontation network (GAN), Variational Automatic Encoder (VAE), Diffusion model (Diffusion), and Large Language Model (LLM), etc., which have their respective advantages in different fields and applications.

The virtual resource, also referred to as a live-streaming virtual resource, refers to a virtual resource object to be displayed in a live-streaming room, such as a live-streaming room gift.

The virtual avatar animation is an animation generated based on a virtual avatar. For example, the virtual avatar animation is a virtual resource object animation, and the virtual resource object animation is provided as a live-streaming room gift and is displayed in the live-streaming room. For example, the virtual avatar animation is an animation of a cartoon character or an animation of a science fiction character. The virtual avatar animation is generated through an artificial intelligence technology, such as the artificial intelligence generative model, based on the object image information of the live-streaming room object associated with the live-streaming room.

In some embodiments, the terminal collects the object image information of the live-streaming room object associated with the live-streaming room and acquires the virtual avatar animation matched with the object image information. For example, the terminal acquires the corresponding virtual avatar animation by using the artificial intelligence generative model based on the collected object image information. For another example, the terminal sends the object image information to the virtual avatar generation server, and the virtual avatar generation server generates, based on the object image information sent by the terminal, the virtual avatar animation matched with the object image information using the artificial intelligence generative model, and returns the virtual avatar animation to the terminal 101, so that the terminal acquires the virtual avatar animation and configures the virtual avatar animation as the virtual resource of the live-streaming room. In some embodiments, the terminal is a terminal logged in with an audience account. The terminal is capable of obtaining the image information such as an avatar of the anchor accounts and/or avatar of a cohost anchor account that is in joint live streaming with the anchor account in the live-streaming room. The avatars of the anchor account and/or the cohost anchor account are processed to acquire the virtual avatar animations as virtual resources associated with a live-streaming room. In this way, the virtual resources can be customized in the live-streaming room, and types of the virtual resources are diversified.

In 202, the terminal displays the virtual avatar animation in the live-streaming room in response to a triggering condition for transferring the virtual resource being satisfied.

The triggering condition for transferring the virtual resource refers to a transfer-triggering condition of the virtual resource. In some embodiments, the transfer-triggering condition refers to a condition triggered by a transfer operation on the virtual resource. The transfer operation is triggered by the audience account in the live-streaming room for transferring the virtual resource to the anchor account, or transferring the virtual resource to another account associated with the anchor account by the audience account. For example, another account associated with the anchor account refers to the account that are in multi-host live steaming or in joint live streaming with the anchor account. In other words, the transfer operation is an operation performed by the audience object in the live-streaming room to transfer the virtual resource to the anchor object, or the transfer operation is an operation performed by the audience object to transfer the virtual resource to another object associated with the anchor object, and the another object refers to another anchor object that is in joint live streaming with the anchor object, or refers to a virtual anchor object that is controlled by the anchor object, or the like.

In 202, the terminal displays the virtual avatar animation in the live-streaming room in the case of satisfying a transfer-triggering condition of the virtual resource.

In some embodiments, in the case that the triggering condition for transferring the virtual resource has been detected, that is, in the case that the triggering condition for transferring the virtual resource is satisfied, the terminal displays the virtual avatar animation acquired in 201. In some embodiments, the acquired virtual avatar animation may be stored and configured to be in a lock state as described below. The virtual avatar animation is displayed upon a transfer-triggering condition of the virtual resource is met. In some scenario, the display of the virtual avatar animation in the live-streaming room indicates that the transferring condition is satisfied, or transferring the virtual resource is ongoing. A scene of giving virtual gifts in the live-streaming room is taken as an example. In the case that a transfer operation on a gift in the live-streaming room (that is, a transfer operation performed by the audience object to give a virtual gift to the anchor object) has been detected, the virtual avatar animation is configured as a gift animation of the virtual gift in the live-streaming room, and the virtual avatar animation is displayed or played in the live-streaming room. Based on the above manner, the amount of information carried by the live-streaming virtual resource is increased, and the adaptation degree between the live-streaming virtual resource and the live-streaming room object is improved. The live-streaming virtual resource in the live-streaming room is displayed in a customized manner, thereby improving the diversity of types of the displayed live-streaming virtual resource and the human-computer interaction efficiency.

According to the method for displaying the live-streaming virtual resource, in the case that the transfer-triggering condition of the virtual resource is satisfied, the virtual avatar animation is used as the virtual resource and displayed in the live-streaming room. The virtual avatar animation may be a virtual avatar animation of an avatar of an anchor account, an audience account, or a cohost anchor account. As the virtual avatar animation is matched with the object image information of the live-streaming room object associated with the live-streaming room, the amount of information carried by the live-streaming virtual resource is increased, and the matching degree between the live-streaming virtual resource and the live-streaming room object is improved. The live-streaming virtual resource in the live-streaming room is displayed in a personalized manner, thereby improving the diversity of types of the displayed live-streaming virtual resource and the human-computer interaction efficiency.

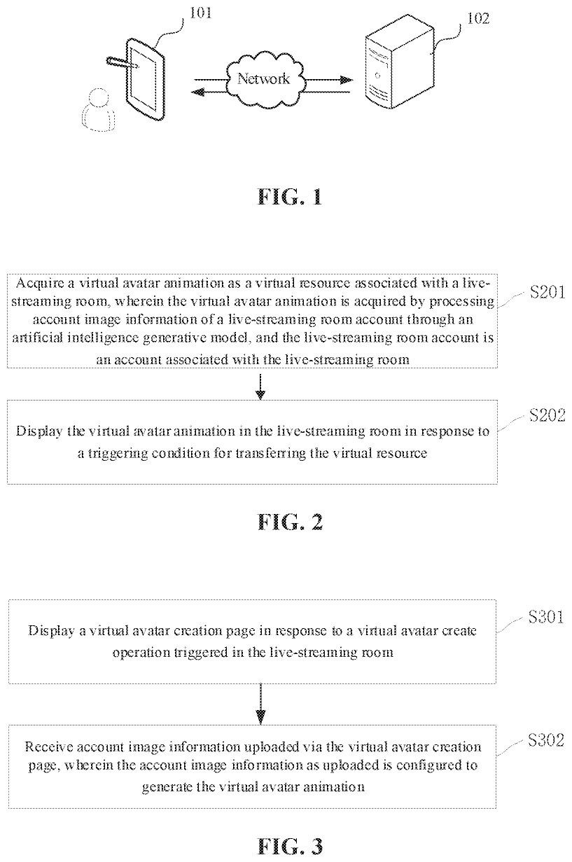

In some embodiments, as shown in FIG. 3, the method further includes:

In 301, the terminal displays a virtual avatar creation page in response to a virtual avatar create operation triggered in the live-streaming room.

The virtual avatar create operation refers to a trigger operation configured to create the virtual avatar animation. For example, the trigger operation is triggered by an account logged in with the terminal or by the anchor account of the live-streaming room. In other words, the live-streaming room object triggers the virtual avatar create operation in the live-streaming room, so as to trigger the creation of the virtual avatar animation.

The virtual avatar creation page is a presentation page configured to create a virtual avatar. The virtual avatar creation page is an example of a virtual avatar creation interface. The virtual avatar creation interface is a presentation interface configured to create a virtual avatar. The virtual avatar creation interface includes, but is not limited to, a web page, an H5 page (i.e., a mobile version of website opened in a browser), a function interface provided in an application, a function window popped up in an application, and the like.

In 301, the terminal displays a virtual avatar creation interface in response to a virtual avatar create operation triggered in the live-streaming room. In some embodiments, in the case that the anchor account needs to display a virtual resource in the form of the virtual avatar animation in the live-streaming room, the virtual avatar create operation is triggered in the live-streaming room. For example, the virtual avatar create operation is triggered by clicking a virtual avatar create control displayed in the live-streaming room, and afterwards, the terminal displays the virtual avatar creation interface (for example, the virtual avatar creation page) in the live-streaming room in response to the virtual avatar create operation.

In 302, the terminal receives account image information uploaded via the virtual avatar creation page, wherein the account image information as uploaded is configured to generate the virtual avatar animation.

The virtual avatar creation page is an example of the virtual avatar creation interface, and the account image information is an example of the object image information. In 302, the terminal receives the object image information uploaded via the virtual avatar creation interface, wherein the object image information as uploaded is configured to generate the virtual avatar animation.

In some embodiments, after the terminal displays the virtual avatar creation interface, the anchor object uploads the object image information via the virtual avatar creation interface. For example, the anchor object uploads a facial image via the virtual avatar creation interface, such that the terminal receives the object image information as uploaded to generate the matched virtual avatar animation. In one example, the facial image is an avatar of the anchor account. In some examples, one or more object information (e.g., an avatar) is displayed on the virtual avatar creation interface, the anchor object may select the object information and upload the object image by triggering an upload control. In some embodiments, the terminal generates the matched virtual avatar animation after receiving the object image information as uploaded, or the terminal sends the object image information as uploaded to the virtual avatar generation server, and the virtual avatar generation server generates the matched virtual avatar animation.

In some embodiments, the terminal uses the object image information uploaded via the virtual avatar creation interface as the object image information for generating the virtual avatar animation, such that the generated virtual avatar animation is more in line with the object image information, thereby further improving the intelligence of generating the virtual avatar animation.

In some embodiments, the virtual avatar creation interface further includes an object image uploading region. Step 302 further includes: an object image as uploaded is acquired in response to an object image upload operation triggered in the object image uploading region, and the object image is displayed in the object image uploading region; and the object image as uploaded is determined as the object image information in response to a determine operation for applying the object image as uploaded to generating the virtual avatar animation.

The object image uploading region refers to an interface region configured to upload the object image in the virtual avatar creation interface. For example, in the case that the virtual avatar creation interface is the virtual avatar creation page, the object image uploading region is provided as an account image uploading region of the virtual avatar creation page. The account image uploading region is a page region configured to upload an account image in the virtual avatar creation page, and the virtual avatar creation page in some embodiments includes a region specially configured to upload the account image. In some embodiments, the account logged in with the anchor terminal triggers an account image upload operation in the account image uploading region. For example, the account image uploading region is clicked to trigger the account image upload operation. In this case, the terminal acquires, in response to the upload operation, the account image uploaded in the account image uploading region and displays the uploaded account image. The account image may be an image or an avatar of the objects in the live-streaming room such as an image or an avatar of an anchor account. The account image upload operation is an example of the object image upload operation.

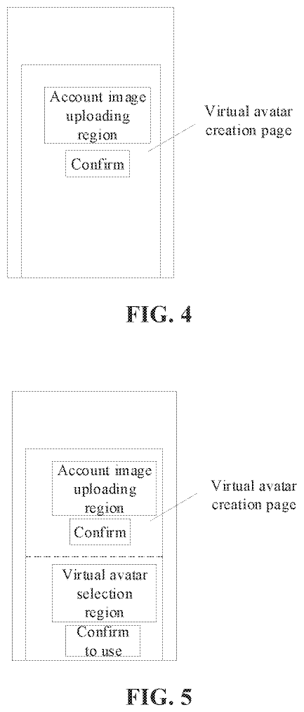

Afterwards, in the case that the account logged in with the terminal determines the uploaded account image as an account image used to generate the virtual avatar animation, the account logged in with the terminal triggers, on the virtual avatar creation page, a determine operation for applying the uploaded account image to generating the virtual avatar animation. In some examples, the account logged in with the terminal is an audience account. In one example, the triggering of the determine operation is achieved by clicking a confirm control by the account. The terminal determines the account image as the account image information in response to the determine operation. In an exemplary embodiment shown in FIG. 4, the displayed virtual avatar creation page includes the account image uploading region. In some examples, the account image uploading region is indicated by a text such “Upload” or a frame with a text “Upload” inside the frame. The account image upload operation is triggered by the audience account on any point on the account uploading region. The account logged in with the terminal triggers the account image upload operation by clicking the account image uploading region, and the uploaded account image is displayed in the account image uploading region. Afterwards, the account logged in with the terminal triggers the determine operation for applying the uploaded account image to generate the virtual avatar animation by clicking a “Confirm” button in the account image uploading region, such that the terminal determines the account image uploaded by the account as the account image information for generating the virtual avatar animation.

In other words, in the case that the account logged in with the terminal determines the uploaded object image as an object image to be used to generate the virtual avatar animation, the account logged in with the terminal triggers, on the virtual avatar creation interface, a determine operation of applying the uploaded object image to generate the virtual avatar animation. For example, the triggering of the determine operation is achieved by clicking a confirm control by the account. The terminal determines the object image as the object image information in response to the determine operation.

In some embodiments, the terminal provides the object image uploading region in the virtual avatar creation interface, and the live-streaming room object uploads the object image in the object image uploading region, such that the step of uploading the object image is simplified, thereby improving the efficiency of uploading the object image.

In some embodiments, the virtual avatar creation interface further includes a virtual avatar selection region. The method further includes the following steps: a plurality of candidate virtual avatar images matched with the object image information are acquired; the plurality of candidate virtual avatar images are displayed in the virtual avatar selection region; and a target virtual avatar image as selected is acquired in response to a select operation on any of the displayed candidate virtual avatar images, wherein the target virtual avatar image is configured to generate the virtual avatar animation matched with the object image information.

The virtual avatar selection region is a region where the account logged in with the terminal selects the virtual avatar. In some embodiments, there is one or a plurality of virtual avatars matched with the object image information. In the case that the object image information has a plurality of matched virtual avatars, the terminal generates the plurality of matched candidate virtual avatar images based on the uploaded object image information. The candidate virtual avatar images are generated locally by the terminal, or the terminal sends the object image information to the virtual avatar generation server, and the virtual avatar generation server generates the plurality of matched candidate virtual avatar images based on the object image information and then returns the plurality of candidate virtual avatar images to the terminal. Then, the terminal displays the plurality of candidate virtual avatar images in the virtual avatar selection region in the virtual avatar creation interface.

In some examples, the virtual avatar creation interface refers to the virtual avatar creation page, the object image information refers to the account image information, and the object image refers to the account image. In the case that a plurality of virtual avatars matched with the account image information exist, the terminal generates a plurality of matched virtual avatar images based on the account image uploaded by the account, namely, the plurality of candidate virtual avatar images; or the terminal sends the account image uploaded by the account to the virtual avatar generation server, and the virtual avatar generation server generates the plurality of candidate virtual avatar images based on the uploaded account image and returns the candidate virtual avatar images to the terminal. Afterwards, the terminal displays the plurality of candidate virtual avatar images in the virtual avatar selection region in the virtual avatar creation page,
wherein the target virtual avatar image refers to a virtual avatar image that is configured for generating the virtual avatar animation. After the terminal displays the plurality of candidate virtual avatar images matched with the object image information in the virtual avatar selection region, the account logged in with the terminal selects a target virtual avatar image from among the plurality of candidate virtual avatar images, and the terminal determines the target virtual avatar image selected by the account as the object image for generating the virtual avatar animation.

In some embodiments, the virtual avatar creation interface refers to the virtual avatar creation page, the object image information refers to the account image information, and the object image refers to the account image. After the terminal displays the plurality of candidate virtual avatar images matched with the account image information in the virtual avatar selection region, the account logged in with the terminal selects a target virtual avatar image from among the plurality of candidate virtual avatar images, and the terminal determines the target virtual avatar image selected by the account as the account image configured for generating the virtual avatar animation. Referring to FIG. 5, FIG. 5 schematically illustrate a virtual avatar creation page according to some embodiments of the present disclosure. As shown in FIG. 5, a virtual avatar creation page includes an account image uploading region, and a confirmation control configured to trigger a determine operation to upload an account image. The confirmation control is disposed below the account image upload region. The virtual avatar creation page further includes the virtual avatar selection region, which is disposed under the account image uploading region. The virtual avatar selection region may display a plurality of candidate virtual avatar images matched with the object image information. A control configured to confirm the selection of a target candidate virtual avatar image is disposed adjacent to the virtual avatar selection region. In the illustrated embodiment, the control is a “confirm to use” button and is disposed below the virtual avatar selection region. After the account clicks the Confirm button on the account image uploading region and completes the uploading of the account image information, the terminal displays the plurality of candidate virtual avatar images in the virtual avatar selection region for the account to select. The account can select a target virtual avatar image by click a candidate virtual avatar image. In the case that the account clicks the “Confirm to use” button, the terminal determines a candidate virtual avatar image selected by the account as the target virtual avatar image to generate the virtual avatar animation.

In some embodiments, the terminal displays the plurality of candidate virtual avatar images matched with the object image information in the virtual avatar selection region, and the account selects the target virtual avatar image configured to generate the virtual avatar animation from the candidate virtual avatar images, such that the diversity of selecting the virtual avatar images is improved, and the diversity of the virtual avatar animation is further improved.

In some embodiments, the virtual avatar creation interface further includes a default avatar select control. As shown in FIG. 6, the method for displaying the live-streaming virtual resource further includes the following steps:

In 601, the terminal displays a plurality of preset default virtual avatar images in response to a trigger operation on the default avatar select control,
wherein the default avatar select control refers to a control configured to select a default virtual avatar, and the default virtual avatar refers to a virtual avatar preset by the terminal.

In 601, the terminal displays a plurality of default virtual avatar images in response to a trigger operation on the default avatar select control. In some embodiments, in the case that the account logged in with the terminal does not wish to generate the virtual avatar animation by using the object image information of the live-streaming room object, the virtual avatar animation is generated based on a preset default virtual avatar. For example, the virtual avatar creation interface refers to the virtual avatar creation page. A default avatar select control is further configured on the virtual avatar creation page. In the case that the account clicks the default avatar select control, a trigger operation on the default avatar select control is detected. In this case, the terminal displays, in response to the trigger operation, the plurality of preset default virtual avatar images on the virtual avatar creation page.

In 602, the terminal acquires a selected default virtual avatar image in response to a select operation performed on the displayed default virtual avatar images, wherein the selected default virtual avatar image is configured to generate the virtual avatar animation matched with the selected default virtual avatar image as the virtual resource associated with the live-streaming room.

In 602, the terminal acquires a selected default virtual avatar image in response to a select operation on any of the default virtual avatar images, wherein the selected default virtual avatar image is used to generate the virtual avatar animation. After the terminal displays the default virtual avatar images, the account logged in with the terminal performs the select operation on the above displayed default virtual avatar images to select, from the default virtual avatar images, a default virtual avatar image for generating the virtual avatar animation. For example, the terminal displays, on the virtual avatar creation page, the plurality of default virtual avatar images, which are respectively virtual avatar A, virtual avatar B, and virtual avatar C. In the case that the account selects virtual avatar C, virtual avatar C is used to generate the virtual avatar animation.

In 603, the terminal displays, in response to the triggering condition for transferring the virtual resource, the virtual avatar animation matched with the selected default virtual avatar image.

In 603, the terminal displays, in the case that the transfer-triggering condition of the virtual resource is satisfied, the virtual avatar animation matched with the selected default virtual avatar image. In other words, in the case that the terminal has detected that the transfer-triggering condition of the virtual resource is satisfied, the terminal configures the virtual avatar animation matched with the default virtual avatar image selected at step 602 as the virtual resource associated with the live-streaming room and displays the virtual avatar animation in the live-streaming room.

In the embodiments of the display disclosure, the terminal provides the default avatar select control on the virtual avatar creation interface, ensuring that in the case that the account does not wish to generate the virtual avatar animation by using the object image information of the live-streaming room object, the account selects, through the default avatar select control, the default virtual avatar image to generate the virtual avatar animation matched with the default virtual avatar image, thereby displaying the virtual avatar animation matched with the default virtual avatar image and providing the account with more types of manners for displaying the live-streaming virtual resource.

In some embodiments, step 201 further includes: the object image information is sent to a virtual avatar generation server, wherein the virtual avatar generation server is configured to acquire, by processing the received object image information through the artificial intelligence generative model, the virtual avatar animation matched with the object image information; and the virtual avatar animation returned by the virtual avatar generation server is received, and the virtual avatar animation is set to be in a virtual resource-locked state. Step 202 further includes: the virtual resource-locked state of the virtual avatar animation is released in the case that the live-streaming room satisfies a preset virtual resource unlocking condition.

The virtual avatar generation server is for example the virtual avatar generation server 102 in FIG. 1, and the object image information is for example the account image information.

In some embodiments, the virtual avatar animation is generated by the virtual avatar generation server through the artificial intelligence generative model based on the collected object image information. For example, the object image information refers to the account image information, and the virtual avatar animation is generated by the virtual avatar generation server through the artificial intelligence generative model based on the collected account image information. In some embodiments, the terminal sends the collected account image information to a server configured to generate a virtual avatar, that is, to the virtual avatar generation server, and the virtual avatar generation server generates the matched virtual avatar animation through the artificial intelligence generative model based on the received account image information. Afterwards, the virtual avatar generation server returns the generated virtual avatar animation to the terminal. After receiving the virtual avatar animation returned by the virtual avatar generation server, the terminal sets the virtual avatar animation to be in the virtual resource-locked state. The virtual avatar animation in the virtual resource-locked state is unable to be displayed in the live-streaming room. In the case that the live-streaming room satisfies the preset virtual resource unlocking condition, the terminal releases the locked state of the virtual avatar animation. In this case, the virtual avatar animation is configured as the virtual resource, such that the virtual avatar animation is displayed in the live-streaming room.

In the embodiments of the display disclosure, the terminal sends the object image information to the virtual avatar generation server, and the virtual avatar generation server generates the virtual avatar animation, thereby reducing the consumption of computing resources used by the terminal to generate the virtual avatar animation. Further, the virtual avatar animation is set to be in the virtual resource-locked state after being acquired. The locked state of the virtual avatar animation is released in the case that the live-streaming room satisfies the preset virtual resource unlocking condition, ensuring that the virtual avatar animation is displayed as the virtual resource in the live-streaming room in the case that the live-streaming room satisfies the preset virtual resource unlocking condition. This improves the accuracy of playing the virtual avatar animation.

Further, the locked state of the virtual avatar animation is released in the case that the live-streaming room satisfies the preset virtual resource unlocking condition, which includes the following steps: the virtual resource-locked state is released in the case that the anchor object of the live-streaming room satisfies a preset object condition; and/or, the virtual resource-locked state is released in the case that a live-streaming room object behavior associated with the live-streaming room satisfies a preset object behavior condition.

In the embodiments of the present disclosure, the manner of determining whether the live-streaming room satisfies the preset virtual resource unlocking condition is mainly based on the following two types of conditions: determination based on the anchor object in the live-streaming room or determination based on the live-streaming room object behavior associated with the live-streaming room. In some embodiments, the anchor object refers to the anchor account, and the live-streaming room object behavior refers to a live-streaming room account behavior. In this case, determination based on the anchor account of the live-streaming room and/or determination based on the live-streaming room account behavior associated with the live-streaming room are supported. In some embodiments, the determination based on the anchor account of the live-streaming room refers to determining whether the anchor account of the live-streaming room satisfies a preset account condition, for example, determining whether an account level of the anchor account in the live-streaming room satisfies a set account level, or determining whether the quantity of accounts that follows the anchor account reaches a set quantity of accounts, or the like. In the case that the anchor account of the live-streaming room satisfies the set account condition, the terminal releases the locked state of the virtual avatar animation. In some embodiments, the determination based on the live-streaming room account behavior associated with the live-streaming room refers to determining whether the account behavior of the live-streaming room satisfies a preset account behavior condition, for example, determining whether the quantity of comments in the live-streaming room reaches a set quantity of comments, or determining whether the quantity of transferred virtual resources in the live-streaming room reaches a set quantity of transferred resources, or the like. In the case that the live-streaming room account behavior satisfies the preset account behavior condition, the terminal releases the locked state of the virtual avatar animation.

In the embodiments of the present disclosure, the terminal determines whether to release the locked state of the virtual avatar animation by determining whether the anchor object associated with the live-streaming room satisfies the preset object condition or determining whether the live-streaming room object behavior associated with the live-streaming room satisfies the preset object behavior condition. In this way, the diversity of manners for releasing the locked state of the virtual avatar animation is improved.

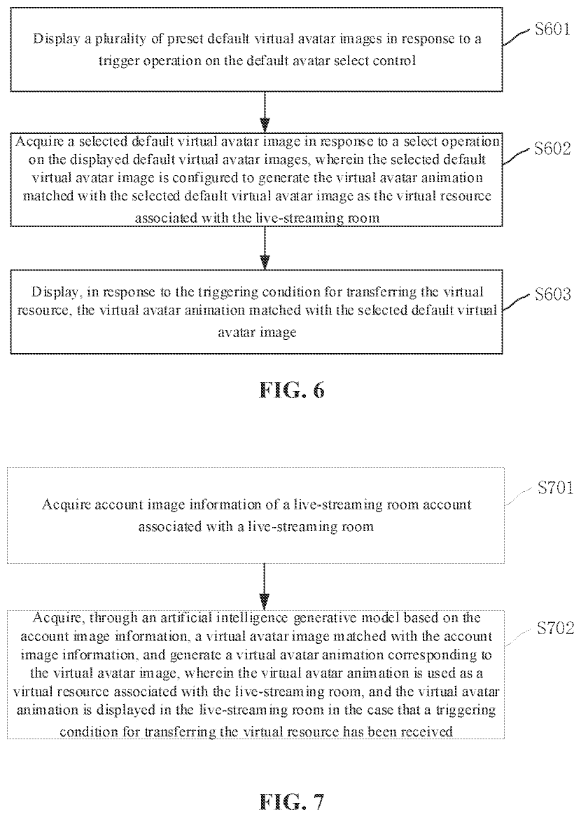

FIG. 7 is a flowchart of another method for displaying a live-streaming virtual resource according to some embodiments. As shown in FIG. 7, the method for displaying the live-streaming virtual resource is executed by a server. The server is for example the virtual avatar generation server 102 in FIG. 1.

In 701, the server acquires account image information of a live-streaming room account associated with a live-streaming room.

The server refers to a server configured to generate a virtual avatar animation based on an object image, and for example, refers to the virtual avatar generation server 102 in FIG. 1.

In 701, the server acquires object image information of a live-streaming room object associated with a live-streaming room. For example, the live-streaming room object refers to a live-streaming room account, the object image is an account image, and the object image information is account image information. The object may be an anchor, a cohost anchor or a plurality of audience in the live-streaming room. In such a case, the virtual avatar generation server is a server configured to generate the virtual avatar animation according to the account image. In the embodiments of the display disclosure, the virtual avatar generation server receives the account image information, sent by the terminal, of the live-streaming room account associated with the live steaming room, thus acquiring the account image information configured to generate a virtual avatar animation. The terminal may be a terminal logged in with an audience account or an anchor account.

In 702, the server acquires, through an artificial intelligence generative model according to the account image information, a virtual avatar image matched with the account image information, and generates a virtual avatar animation corresponding to the virtual avatar image. The virtual avatar animation is used as a virtual resource associated with the live-streaming room, and the virtual avatar animation is displayed in the live-streaming room in the case that a triggering condition for transferring the virtual resource has been received.

The virtual avatar image refers to a presentation image of a virtual avatar, and the virtual avatar animation refers to an animation generated after the virtual avatar is driven.

In 702, the server acquires, based on the object image information through an artificial intelligence generative model, a virtual avatar image matched with the object image information, and generates a virtual avatar animation adapting to the virtual avatar image, wherein the virtual avatar animation is provided as a virtual resource associated with the live-streaming room, such that the virtual avatar animation can be displayed in the live-streaming room in response to satisfying a transfer-triggering condition of the virtual resource.

In the embodiments of the present disclosure, the object image information referring to the account image information is taken as an example. After receiving the account image information, the virtual avatar generation server first acquires, through an artificial intelligence generative model based on the account image information, the virtual avatar image matched with the account image information, and then drives the virtual avatar image to move, thereby generating the virtual avatar animation adapting to the virtual avatar image. Afterwards, the virtual avatar animation is returned to the terminal by the virtual avatar generation server, and the terminal displays the virtual avatar animation as the virtual resource in the live-streaming room in which the user account of the terminal participates in the case that the live-streaming room satisfies the transfer-triggering condition of the virtual resource.

In the method for displaying the live-streaming virtual resource, the virtual avatar animation matched with the object image information of the live-streaming room object is generated through the virtual avatar generation server, such that the virtual avatar animation is configured as the virtual resource in the case of satisfying the transfer-triggering condition of the virtual resource, and the virtual avatar animation is displayed in the live-streaming room. Thus, display of the live-streaming virtual resource in the live-streaming room is individualized, the amount of information carried by the live-streaming virtual resource is increased, and the adaptation degree between the live-streaming virtual resource and the live-streaming room object is improved, thereby improving the diversity of types of the displayed live-streaming virtual resource and improving the human-computer interaction efficiency.

In some embodiments, as shown in FIG. 8, step 702 further includes:

In 801, the server acquires a pre-stored body animation, and extracts a body image from the body animation.

The body animation refers to a body animation of the virtual avatar. In some embodiments, the body animation is stored in advance in a database of the virtual avatar generation server. The database of the virtual avatar generation server stores various body animations. In the process of generating the virtual avatar image, the virtual avatar generation server extracts the body image serving as a virtual avatar body from the stored body animations, for example, extracts an initial frame of the body animation, and determines the initial frame as the body image.

In 802, the server acquires an account facial image of the live-streaming room account by performing head segmentation on the account image information.

In 802, the server acquires an object facial image of the live-streaming room object by performing head segmentation on the object image information. The account image information is an example of the object image information, the live-streaming room account is an example of the live-streaming room object account, and the account facial image is an example of the object facial image. Based on the above examples, the account facial image refers to a facial image in the account image. The account image information acquired by the terminal includes the facial image of the live-streaming room account. Therefore, the virtual avatar generation server acquires the account facial image of the live-streaming room account by performing the head segmentation on the account image information.

In 803, the server combines the body image with the account facial image and generates a stylized image corresponding to a combined image by using the artificial intelligence generative model, and determines the stylized image as the virtual avatar image.

After the body image is acquired in 801 and the account facial image (namely, the object facial image) is acquired in 802, in 803, the server acquires a combined image by combining the body image with the object facial image, then generates a stylized image from the combined image by using the artificial intelligence generative model, and sets the stylized image as the virtual avatar image.

The object facial image being the account facial image is taken as an example. The virtual avatar generation server performs positioning combination on the body image and the account facial image to acquire the combined image by combining the body image with the account facial image. Afterwards, the virtual avatar generation server stylizes the combined image by using an artificial intelligence image generation technology, that is, the artificial intelligence generative model, so as to generate the stylized image for the combined image. For example, the virtual avatar generation server performs cartoon stylization on the combined image to acquire a stylized image with a cartoon style, and then sets the stylized image as the virtual avatar image matched with the account image information.

In the embodiments of the present disclosure, the virtual avatar generation server extracts the body image from the pre-stored body animation, separates the facial image from the object image information, combines the body image with the facial image, and performs the stylization processing through the artificial intelligence technology to generate the virtual avatar image, so as to improve the generation efficiency of the virtual avatar image.

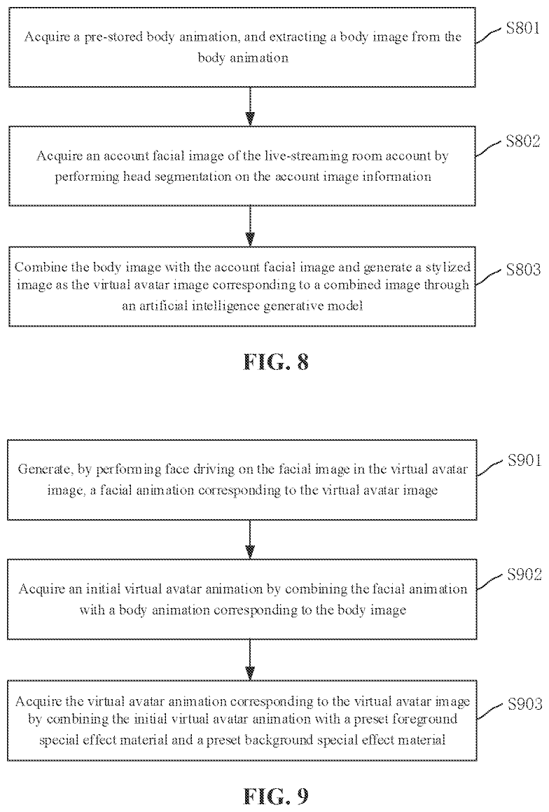

Further, as shown in FIG. 9, step 702 further includes the following steps:

In 901, the server generates, by performing face driving on the facial image in the virtual avatar image, a facial animation corresponding to the virtual avatar image.

In 901, the server acquires, by performing face driving on the facial image in the virtual avatar image, a facial animation adapting to the virtual avatar image. The facial animation refers to a facial animation of the virtual avatar. After acquiring the virtual avatar image, the virtual avatar generation server performs the face driving on the facial image in the virtual avatar image, for example, through a virtual digital person making tool such as SadTalker, to generate a dynamic face video. The mouth, eyes and the like in the face video change to a certain extent, and the face video is determined as the facial animation adapting to the virtual avatar image.

In 902, the server acquires an initial virtual avatar animation by combining the facial animation with a body animation corresponding to the body image.

In 902, the server acquires a body animation adapting to the body image, and acquires an initial virtual avatar animation by combining the facial animation generated in 901 with the acquired body animation.

In 903, the server acquires the virtual avatar animation corresponding to the virtual avatar image by combining the initial virtual avatar animation with a preset foreground special effect material and a preset background special effect material.

The initial virtual avatar animation refers to a virtual avatar animation without special effect information, wherein the special effect information includes the foreground special effect material and the background special effect material. In some embodiments, the foreground special effect material and the background special effect material are stored in advance in the database of the virtual avatar generation server. In some embodiments, the virtual avatar generation server recombines the facial animation acquired in 901 with the body animation acquired in 801 to generate an initial virtual avatar animation, and acquires, by combining the initial virtual avatar animation with a preset foreground special effect material and a preset background special effect material, the virtual avatar animation adapting to the virtual avatar image.

In the embodiments of the present disclosure, after acquiring the facial animation by performing the face driving on the facial image in the virtual avatar image, the virtual avatar generation server combines the facial animation with the body animation, and acquires the final virtual avatar animation by combining the combined initial virtual avatar animation with the foreground special effect material and the background special effect material, such that the reality of the virtual avatar animation is improved.

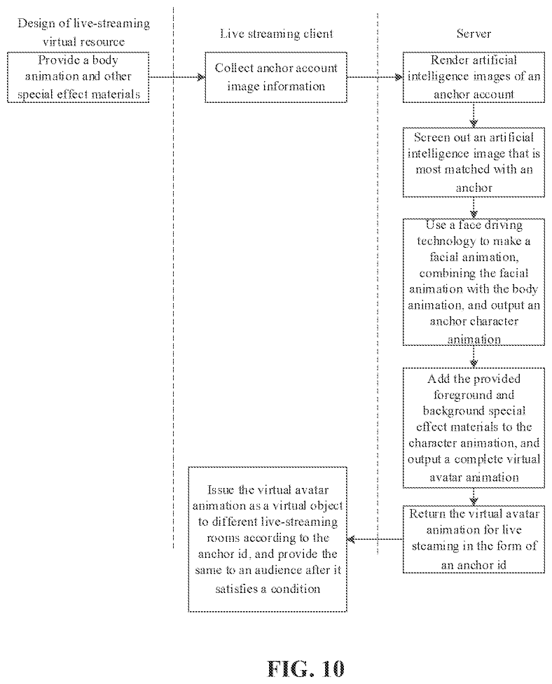

FIG. 10 is a flowchart of another method for displaying a live-streaming virtual resource according to some embodiments. As shown in FIG. 10, the method is implemented by the following steps. First, design of live-streaming virtual resource is provided. In some embodiments, a body animation and other special effect materials are provided to a live streaming client such as a terminal of an audience client. In some embodiment, the design information of live-streaming virtual resource may be stored in a database of a server (a virtual avatar generation server/a live-streaming server). Next, the method may include collecting anchor account image information. An authorization and account image information of an anchor profile are acquired, that is, an anchor client collects anchor account image information. An account image is a profile authorized by an anchor or a default fixed image, and the account image is determined based on the authorization behavior of a user. The account image information here is the account image of the anchor or an account image of another live-streaming room user or an account image of an audience. The account image information is an example of object image information.

Next, the method may include generating, by a server, artificial intelligence image of an anchor account. The live-streaming virtual object is bound to an anchor ID. This step may further include the following processes: rendering artificial intelligence images of the anchor account and screening out an artificial intelligence image that is most matched with the anchor. In some embodiments, these processes can be performed as below.

(1) Head segmentation (including regions such as the face, the hairs, and the hat) is performed on the acquired account image, and a head segmentation result and an initial frame of a body animation (marked as a₀) are positioned and combined to form an image with a real person face and the body animation, which is marked as x₀. That is, the live-streaming client sends the collected account image information to a server. The server acquires the account facial image of the anchor account by performing the head segmentation on the account image information, configures the initial frame of the body animation a₀ as a body image, and combines the body image with the account facial image to form the combined image x₀.

(2). An artificial intelligence generated content (AIGC) technology is used. In some embodiments, the combined image x₀ is processed through a diffusion model, a generative adversarial model, and the like to generate a 2D stylized profile picture (a stylized face for example), marked as x₁. During processing, a stylization technology capable of keeping an account image ID needs to be adopted. For example, the stylization technology is achieved through a diffusion model Controlnet, an artificial intelligence image drawing model Dreambooth, and the like, such that the stylized image x₁ still maintains features of the account image of the anchor. That is, the server generates the stylized image x₁ from the combined image x₀ by using the artificial intelligence generative model, and the stylized image x₁ is a virtual avatar image configured to generate a virtual avatar animation.

Next, the method may include using, by the server, a face driving technology to make the facial animation, combining the facial animation with the body animation, and outputting an anchor character animation. In some embodiments, these processes can be performed as below.

(1). A face driving technology, such as SadTalker and DID, is used to drive the stylized face x₁, such that a dynamic face video is generated, which is marked as v₁, for example, the mouth, the eyes, and the like each change to a certain extent. That is, the server acquires a facial animation v₁ by performing the face driving on the facial image in the stylized image x₁.

(2). The head (including the face, the hairs, the hat, and other regions) of the dynamic face video v₁ is recombined with the body animation a₀ to form a video with the head and the body both dynamic, marked as v₂. That is, the server combines the facial animation v₁ with the body animation a₀ to form an initial virtual avatar animation v₂.

Next, the method may include adding, by the server, the provided foreground and background special effect materials to the character animation and outputting the complete virtual avatar animation. In some embodiments, the process can be performed as below. The video v₂ (i.e., the initial virtual avatar animation v₂) is combined with the foreground and background special effect materials, and a complete virtual avatar animation is output. That is, the server acquires the complete virtual avatar animation by combining the initial virtual avatar animation v₂ with the foreground special effect material and the background special effect material.

Next, the method may include returning, by the server, the virtual avatar animation for live streaming in the form or an anchor ID.

The body animation and other special effect materials in the above steps are designed and provided by the live-streaming virtual object.

Next, the method may include issuing the virtual avatar animation as a virtual object to different live-streaming rooms according to the anchor ID, and providing the virtual avatar animation to an audience after a condition is satisfied. The virtual avatar animation is in a locked state in a live-streaming virtual object panel, and is unlocked in the case of satisfying a condition. For example, the condition is that the user completes a specific task, a level of a current anchor satisfies a set level, or the like. In some embodiments, the above condition is a preset fixed condition of a live-streaming platform, or is individually and dynamically generated according to behavior data of the live-streaming room.

According to the embodiments of the present disclosure, the live-streaming room object being a live-streaming room account, especially the anchor account, is taken as an example. The account image of the live-streaming room account is used to generate the adaptive virtual avatar animation which is displayed as the live-streaming virtual resource, such that the type of the live-streaming room virtual object is enriched, and the individualization degree of the live-streaming room is improved.

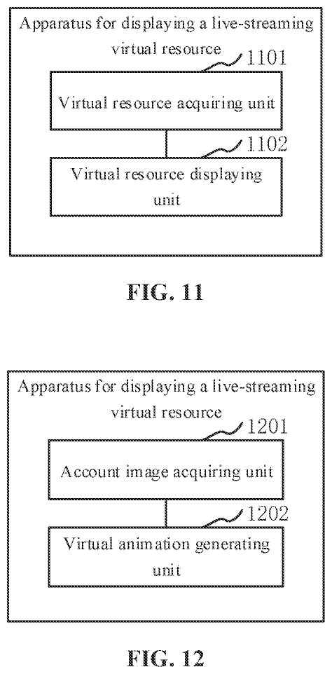

FIG. 11 is a block diagram of an apparatus for displaying a live-streaming virtual resource according to some embodiments. Referring to FIG. 11, the apparatus includes a virtual resource acquiring unit 1101 and a virtual resource displaying unit 1102.

The virtual resource acquiring unit 1101 is configured to: acquire a virtual avatar animation, wherein the virtual avatar animation is acquired by processing object image information of a live-streaming room object through an artificial intelligence generative model, and the live-streaming room object is an object associated with a live-streaming room; and configure the virtual avatar animation as a virtual resource associated with the live-streaming room.

The virtual resource displaying unit 1102 is configured to display the virtual avatar animation in the live-streaming room in response to satisfying a transfer-triggering condition of the virtual resource.

In some embodiments, the apparatus for displaying the live-streaming virtual resource further includes an account image uploading unit, the account image uploading unit is configured to: display a virtual avatar creation interface in response to a virtual avatar create operation triggered in the live-streaming room; and receive the object image information uploaded via the virtual avatar creation interface, wherein the uploaded object image information is configured to generate the virtual avatar animation.

In some embodiments, the virtual avatar creation interface further includes an object image uploading region. The account image uploading unit is further configured to acquire an object image as uploaded in response to an object image upload operation triggered in the object image uploading region, and display the object image in the object image uploading region; and determine the object image as the object image information in response to a determine operation for applying the uploaded object image to generating the virtual avatar animation.

In some embodiments, the virtual avatar creation interface further includes a virtual avatar selection region. The account image uploading unit is further configured to: acquire a plurality of candidate virtual avatar images matched with the object image information; display the plurality of candidate virtual avatar images in the virtual avatar selection region; and acquire a target virtual avatar image as selected in response to a select operation on any of the candidate virtual avatar images, wherein the target virtual avatar image is configured to generate the virtual avatar animation matched with the object image information.

In some embodiments, the virtual avatar creation interface further includes a default avatar select control. The apparatus for displaying the live-streaming virtual resource further includes: a default avatar selecting unit, configured to: display a plurality of preset default virtual avatar images in response to a trigger operation on the default avatar select control; acquire a selected default virtual avatar image in response to a select operation on any of the plurality of default virtual avatar images, wherein the selected default virtual avatar image is configured to generate the virtual avatar animation matched with the selected default virtual avatar image; configure the virtual avatar animation matched with the selected default virtual avatar image as a virtual resource associated with the live-streaming room; and display, in the case that a transfer-triggering condition of the virtual resource is satisfied, the virtual avatar animation matched with the selected default virtual avatar image.

In some embodiments, the virtual resource acquiring unit 1101 is further configured to send the object image information to a virtual avatar generation server, wherein the virtual avatar generation server is configured to acquire, by processing the object image information through the artificial intelligence generative model, the virtual avatar animation matched with the object image information; receive the virtual avatar animation sent by the virtual avatar generation server; and set the virtual avatar animation to be in a virtual resource-locked state. The virtual resource displaying unit 1102 is further configured to release the virtual resource-locked state of the virtual avatar animation in the case that the live-streaming room satisfies a preset virtual resource unlocking condition.

In some embodiments, the virtual resource displaying unit 1102 is further configured to: release the virtual resource-locked state in the case that the anchor object of the live-streaming room satisfies a preset object condition; or, release the virtual resource-locked state in the case that a live-streaming room object behavior associated with the live-streaming room satisfies a preset object behavior condition.

In some embodiments, the virtual avatar generation server is configured to: acquire an object facial image of the live-streaming room object based on the object image information, combine the object facial image with a body image extracted from a body animation, generate a stylized image from a combined image through the artificial intelligence generative model, set the stylized image as an virtual avatar image, and acquire the virtual avatar animation by driving the virtual avatar image.

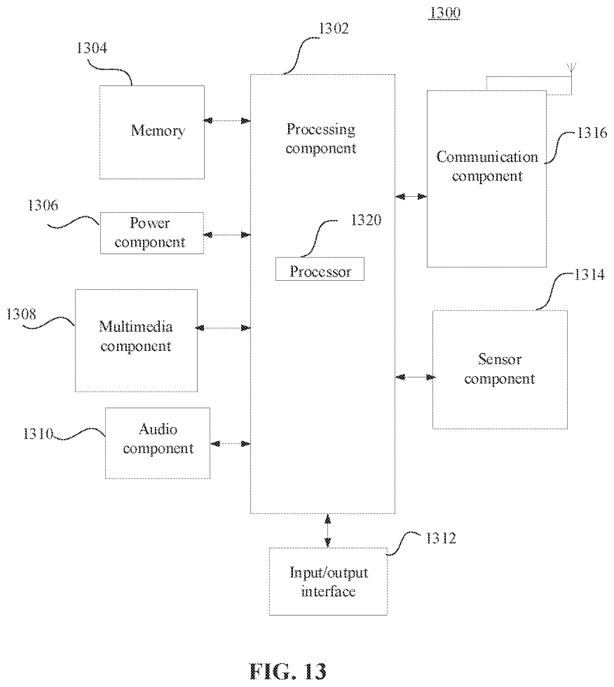

FIG. 12 is a block diagram of another apparatus for displaying a live-streaming virtual resource according to some other embodiments. Referring to FIG. 12, the apparatus includes an account image acquiring unit 1201 and a virtual animation generating unit 1202.

The account image acquiring unit 1201 is configured to acquire object image information of a live-streaming room object associated with a live-streaming room.

The virtual animation generating unit 1202 is configured to: acquire, based on object image information through an artificial intelligence generative model, a virtual avatar image matched with the object image information, and generate a virtual avatar animation adapting to the virtual avatar image, wherein the virtual avatar animation is provided as a virtual resource associated with the live-streaming room; and display the virtual avatar animation in the live-streaming room in response to satisfying a transfer-triggering condition of the virtual resource.

In some embodiments, the virtual animation generating unit 1202 is further configured to: acquire a body animation, extract a body image from the body animation, acquire an object facial image of the live-streaming room object by performing head segmentation on the object image information, acquire a combined image by combining the body image with the object facial image, generate a stylized image from the combined image through the artificial intelligence generative model, and set the stylized image as the virtual avatar image.

In some embodiments, the virtual animation generating unit 1202 is further configured to: acquire a facial animation adapting to the virtual avatar image by performing face driving on the facial image in the virtual avatar image, acquire an initial virtual avatar animation by combining the facial animation with the body animation adapting to the body image, and acquire, by combining the initial virtual avatar animation with a preset foreground special effect material and a preset background special effect material, the virtual avatar animation adapting to the virtual avatar image.

FIG. 13 is a block diagram of a terminal 1300 for displaying a live-streaming virtual resource according to some embodiments. For example, the terminal 1300 is a mobile phone, a computer, a digital broadcast terminal, a message transceiver device, a game console, a tablet device, a medical device, a fitness device, a personal digital assistant, or the like.

Referring to FIG. 13, the terminal 1300 includes one or more of the following components: a processing component 1302, a memory 1304, a power component 1306, a multimedia component 1308, an audio component 1310, an input/output (I/O) interface 1312, a sensor component 1314, and a communication component 1316.

The processing component 1302 generally controls overall operations of the terminal 1300, such as operations associated with display, telephone calls, data communications, camera operations, and recording operations. The processing component 1302 includes one or more processors 1320 to execute instructions to complete all or a portion of the steps of the method described above. Moreover, the processing component 1302 includes one or more modules that facilitate the interactions between the processing component 1302 and other components. For example, the processing component 1302 includes a multimedia module to facilitate the interaction between the multimedia component 1308 and the processing component 1302.

The memory 1304 is configured to store various types of data to support the operations on the terminal 1300. Examples of such data include instructions for any application program or method operated on the terminal 1300, contact data, phonebook data, messages, pictures, videos, and the like. The memory 1304 is implemented by any type or combination of volatile or non-volatile storage devices, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, an optical disk, or a graphene memory.

The power component 1306 provides power for the various components of the terminal 1300. The power component 1306 includes a power management system, one or more power supplies, and other components associated with generating, managing, and distributing power for the terminal 1300.

The multimedia component 1308 includes a screen providing an output interface between the terminal 1300 and a user. In some embodiments, the screen includes a liquid crystal display (LCD) and a touch panel (TP). In the case that the screen includes a touch panel, the screen is implemented as a touch screen to receive an input signal from a user. The touch panel includes one or more touch sensors to sense touch, slides, and gestures on the touch panel. The touch sensors not only sense the boundary of a touch or slide action, but also detect the duration and pressure associated with the touch or slide operation. In some embodiments, the multimedia component 1308 includes a front camera and/or a rear camera. A front camera and/or a rear camera receive external multimedia data in the case that the terminal 1300 is in an operation mode, such as a shooting mode or a video mode. Each of the front camera and the rear camera is a fixed optical lens system or has a focal length and an optical zoom capability.

The audio component 1310 is configured to output and/or input audio signals. For example, the audio component 1310 includes a microphone (MIC) configured to receive external audio signals in the case that the terminal 1300 is in an operation mode, such as a call mode, a recording mode, and a voice recognition mode. The received audio signals are further stored in the memory 1304 or transmitted via the communication component 1316. In some embodiments, the audio component 1310 further includes a loudspeaker configured to output audio signals.

The I/O interface 1312 provides an interface between the processing component 1302 and a peripheral interface module, wherein the peripheral interface module is a keyboard, a click wheel, a button, or the like. These buttons include, but are not limited to: a homepage button, a volume button, a start button, and a lock button.

The sensor component 1314 includes one or more sensors configured to provide various aspects of state evaluation for the terminal 1300. For example, the sensor component 1314 detects an on/off state of the terminal 1300, and the relative positioning of the components, for example, the components are a display and a keypad of the terminal 1300, and the sensor component 1314 further detects a change in position of the terminal 1300 or components of the terminal 1300, the presence or absence of user contact with the terminal 1300, orientation or acceleration/deceleration of the terminal 1300, and a change in temperature of the terminal 1300. The sensor component 1314 includes a proximity sensor configured to detect the presence of nearby objects in the absence of any physical contact. The sensor component 1314 further includes a light sensor, such as a CMOS or CCD image sensor, configured to be used in imaging applications. In some embodiments, the sensor component 1314 further includes an acceleration sensor, a gyroscope sensor, a magnetic sensor, a force sensor, or a temperature sensor.

The communication component 1316 is configured to facilitate the communications between the terminal 1300 and other devices in a wired or wireless manner. The terminal 1300 accesses a wireless network based on a communication standard, such as WiFi, an operator network (such as 2G, 3G, 4G, or 5G), or a combination thereof. In some embodiments, the communication component 1316 receives a broadcast signal or broadcast-associated information from an external broadcast management system via a broadcast channel. In some embodiments, the communication component 1316 further includes a near field communication (NFC) module to facilitate the short-range communications. For example, the NFC module is implemented based on radio frequency identification (RFID) technology, infrared data association (IrDA) technology, ultra wideband (UWB) technology, bluetooth (BT) technology, and other technologies.

In some embodiments, the terminal 1300 is implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements to perform the method described above.

In some embodiments, a computer-readable storage medium including instructions is further provided, such as the memory 1304 including instructions. The above instructions, when executed by the processor 1320 of the terminal 1300, cause the processor 1320 of the terminal 1300 to complete the method described above. For example, the computer-readable storage medium is ROM, random-access memory (RAM), CD-ROM, magnetic tape, floppy disk, optical data storage device, etc.

In some embodiments, a computer program product including instructions is further provided. The instructions, when executed by a processor 1320 of a terminal 1300, cause the processor 1320 of the terminal 1300 to complete the method described above.

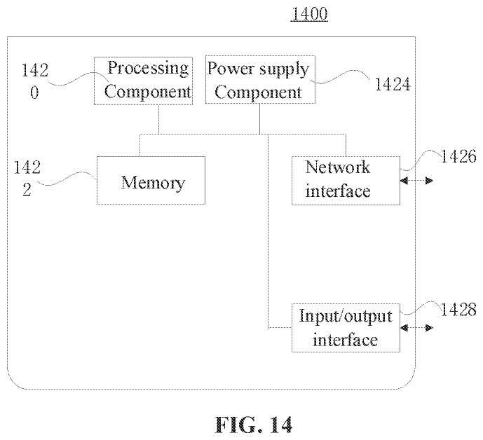

FIG. 14 is a block diagram of a server 1400 for displaying a live-streaming virtual resource according to some embodiments. Referring to FIG. 14, the server 1400 includes a processing component 1420, which further includes one or more processors and a memory resource represented by a memory 1422, configured to store instructions, such as application programs, that can be executed by the processing component 1420. The application programs stored in the memory 1422 include one or more modules, each of which corresponds to a group of instructions. In addition, the processing component 1420 is configured to execute the instructions to perform the method described above.

The server 1400 further includes: a power component 1424 configured to perform power management for the server 1400, a wired or wireless network interface 1426 configured to connect the server 1400 to a network, and an input/output (I/O) interface 1428. The server 1400 operates based on an operating system stored in the memory 1422, such as Windows Server, Mac OS X, Unix, Linux, FreeBSD, or the like.

In some embodiments, a computer-readable storage medium including instructions is further provided, such as the memory 1422 including instructions. The above instructions, when executed by the processor of the server 1400, cause the processor of the server 1400 to complete the method described above. The storage medium is a computer-readable storage medium. For example, the computer-readable storage medium is a ROM, a random-access memory (RAM), a CD-ROM, a magnetic tape, a floppy disk, an optical data storage device, etc.

In some embodiments, a computer program product including instructions is further provided. The instructions, when executed by a processor of the server 1400, cause the processor of the server 1400 to complete the method described above.

What is claimed is:

1. A method for displaying a live-streaming virtual resource, executed by a terminal and comprising:
acquiring a virtual avatar animation, wherein the virtual avatar animation is acquired by processing object image information of a live-streaming room object through an artificial intelligence generative model, and the live-streaming room object is an object associated with a live-streaming room;
configuring the virtual avatar animation as a virtual resource associated with the live-streaming room; and
displaying the virtual avatar animation in the live-streaming room in response to satisfying a transfer-triggering condition of the virtual resource.

2. The method according to claim 1, wherein the method further comprises:
displaying a virtual avatar creation interface in response to a virtual avatar create operation triggered in the live-streaming room; and
receiving the object image information uploaded via the virtual avatar creation interface, wherein the object image information is configured to generate the virtual avatar animation.

3. The method according to claim 2, wherein the virtual avatar creation interface comprises an object image uploading region;
receiving the object image information uploaded via the virtual avatar creation interface comprises:
acquiring an object image as uploaded in response to an object image upload operation triggered in the object image uploading region, and displaying the object image in the object image uploading region; and
determining the object image as the object image information in response to a determine operation for applying the object image to generating the virtual avatar animation.

4. The method according to claim 3, wherein the virtual avatar creation interface further comprises a virtual avatar selection region; the method further comprises:
acquiring a plurality of candidate virtual avatar images matched with the object image information;
displaying the plurality of candidate virtual avatar images in the virtual avatar selection region; and
acquiring a target virtual avatar image as selected in response to a select operation on any of the candidate virtual avatar images, wherein the target virtual avatar image is configured to generate the virtual avatar animation matched with the object image information.

5. The method according to claim 2, wherein the virtual avatar creation interface further comprises a default avatar select control; the method further comprises:
displaying a plurality of default virtual avatar images in response to a trigger operation on the default avatar select control; and
acquiring a selected default virtual avatar image in response to a select operation on any of the plurality of default virtual avatar images, wherein the selected default virtual avatar image is configured to generate the virtual avatar animation matched with the selected default virtual avatar image.

6. The method according to claim 1, wherein acquiring the virtual avatar animation comprises:
sending the object image information to a virtual avatar generation server, wherein the virtual avatar generation server is configured to acquire, by processing the object image information through the artificial intelligence generative model, the virtual avatar animation matched with the object image information; and
receiving the virtual avatar animation sent by the virtual avatar generation server.

7. The method according to claim 6, wherein the virtual avatar generation server is configured to: acquire an object facial image of the live-streaming room object based on the object image information, combine the object facial image with a body image extracted from a body animation, generate a stylized image from a combined image through the artificial intelligence generative model, set the stylized image as an virtual avatar image, and acquire the virtual avatar animation by driving the virtual avatar image.

8. The method according to claim 1, wherein configuring the virtual avatar animation as the virtual resource associated with the live-streaming room comprises:
setting the virtual avatar animation to be in a virtual resource-locked state; and
releasing the virtual resource-locked state of the virtual avatar animation in response to the live-streaming room satisfying a preset virtual resource unlocking condition.

9. The method according to claim 8, wherein releasing the virtual resource-locked state of the virtual avatar animation in response to the live-streaming room satisfying the preset virtual resource unlocking condition comprises:
releasing the virtual resource-locked state in response to an anchor of the live-streaming room satisfying a preset object condition;
or, releasing the virtual resource-locked state in response to a live-streaming room object behavior associated with the live-streaming room satisfying a preset object behavior condition.

10. A method for displaying a live-streaming virtual resource, executed by a server and comprising:
acquiring object image information of a live-streaming room object associated with a live-streaming room;
acquiring, based on the object image information through an artificial intelligence generative model, a virtual avatar image matched with the object image information, and generating a virtual avatar animation adapting to the virtual avatar image, wherein the virtual avatar animation is provided as a virtual resource associated with the live-streaming room; and displaying the virtual avatar animation in the live-streaming room in response to satisfying a transfer-triggering condition of the virtual resource.

11. The method according to claim 10, wherein acquiring, based on the object image information through the artificial intelligence generative model, the virtual avatar image matched with the object image information comprises:
acquiring a body animation, and extracting a body image from the body animation;
acquiring an object facial image of the live-streaming room object by performing head segmentation on the object image information;
acquiring a combined image by combining the body image with the object facial image; and
generating a stylized image from the combined image through the artificial intelligence generative model, and setting the stylized image as the virtual avatar image.

12. The method according to claim 11, wherein generating the virtual avatar animation adapting to the virtual avatar image comprises:
acquiring, by performing face driving on a facial image in the virtual avatar image, a facial animation adapting to the virtual avatar image;
acquiring an initial virtual avatar animation by combining the facial animation with a body animation adapting to the body image; and
acquiring the virtual avatar animation by combining the initial virtual avatar animation with a foreground special effect material and a background special effect material.

13. A terminal, comprising:
a processor; and
a memory configured to store instructions executable by the processor;
wherein the processor, when loading and running the instructions, is caused to perform:
acquiring a virtual avatar animation, wherein the virtual avatar animation is acquired by processing object image information of a live-streaming room object through an artificial intelligence generative model, and the live-streaming room object is an object associated with a live-streaming room;
configuring the virtual avatar animation as a virtual resource associated with the live-streaming room; and
displaying the virtual avatar animation in the live-streaming room in response to satisfying a transfer-triggering condition of the virtual resource.

14. The terminal according to claim 13, wherein the processor, when loading and running the instructions, is caused to perform:
displaying a virtual avatar creation interface in response to a virtual avatar create operation triggered in the live-streaming room; and
receiving the object image information uploaded via the virtual avatar creation interface, wherein the object image information is configured to generate the virtual avatar animation.

15. The terminal according to claim 14, wherein the virtual avatar creation interface comprises an object image uploading region; and the processor, when loading and running the instructions, is further caused to perform:
acquiring an object image as uploaded in response to an object image upload operation triggered in the object image uploading region, and displaying the object image in the object image uploading region; and
determining the object image as the object image information in response to a determine operation for applying the object image to generating the virtual avatar animation.

16. The terminal according to claim 15, wherein the virtual avatar creation interface further comprises a virtual avatar selection region; and the processor, when loading and running the instructions, is further caused to perform:
acquiring a plurality of candidate virtual avatar images matched with the object image information;
displaying the plurality of candidate virtual avatar images in the virtual avatar selection region; and
acquiring a target virtual avatar image as selected in response to a select operation on any of the candidate virtual avatar images, wherein the target virtual avatar image is configured to generate the virtual avatar animation matched with the object image information.

17. The terminal according to claim 14, wherein the virtual avatar creation interface further comprises a default avatar select control; and the processor, when loading and running the instructions, is further caused to perform:
displaying a plurality of default virtual avatar images in response to a trigger operation on the default avatar select control; and
acquiring a selected default virtual avatar image in response to a select operation on any of the plurality of default virtual avatar images, wherein the selected default virtual avatar image is configured to generate the virtual avatar animation matched with the selected default virtual avatar image.

18. The terminal according to claim 13, wherein the processor, when loading and running the instructions, is further caused to perform:
sending the object image information to a virtual avatar generation server, wherein the virtual avatar generation server is configured to acquire, by processing the object image information through the artificial intelligence generative model, the virtual avatar animation matched with the object image information; and
receiving the virtual avatar animation sent by the virtual avatar generation server.

19. The terminal according to claim 13, wherein the processor, when loading and running the instructions, is further caused to perform:
setting the virtual avatar animation to be in a virtual resource-locked state; and
releasing the virtual resource-locked state of the virtual avatar animation in response to the live-streaming room satisfying a preset virtual resource unlocking condition.

20. The terminal according to claim 19, wherein the processor, when loading and running the instructions, is further caused to perform:
releasing the virtual resource-locked state in response to an anchor of the live-streaming room satisfying a preset object condition;
or, releasing the virtual resource-locked state in response to a live-streaming room object behavior associated with the live-streaming room satisfying a preset object behavior condition.
